(19) United States
(12) Patent Application Publication
(10) Pub. No.: US 2003/0190904 A1
(43) Pub. Date: Oct. 9, 2003

(54) FBFN correction method for beam pointing error of LMDS system and a device thereof

(75) Inventors: Jeich Mar, Hsin-Tien City (TW); Lou Shing Lou, Ping Chen City (TW)

Correspondence Address: BACON & THOMAS, PLLC, 625 SLATERS LANE, FOURTH FLOOR, ALEXANDRIA, VA, 22314

(73) Assignee: Far Eastone Telecommunications Co., Ltd., Taipei (TW)

(21) Appl. No.: 10/227,469

(22) Filed: Aug. 26, 2002

(30) Foreign Application Priority Data
Mar. 26, 2002 (TW) 91105850

(51) Int. Cl. H04B 1/06; H04B 7/00

(52) U.S. Cl. 455/277.2; 455/277.1

(57) ABSTRACT

The invention presents a fuzzy basis function network (FBFN) processing device for the beam pointing error correction of the local multipoint distributed system (LMDS). The beam pointing error caused by wind force can affect the performance of the local multipoint distributed system (LMDS). The correction device uses multi-beam planar array antenna to obtain the signal direction-of-arrival (DOA) of a base station and uses fuzzy basis function network (FBFN) algorithm, which includes thirteen normalized Gaussian membership functions and thirteen rules, to estimate the beam pointing error. The simulation results show that the presented FBFN processing device has better performance in transient response, convergence time and steady state value of the averaged square error than the conventional beam pointing error correction devices.

### BACKGROUND OF THE INVENTION

1. Field of the Invention

The invention relates to a method for automatically correcting a beam pointing error at a customer premised equipment (CPE) of a local multipoint distributed system (LMDS) and a device thereof, particularly, to a method for correcting a beam pointing error by using a membership function, which is designed for a beam pointing error distributioin caused by wind force, based on a fuzzy basis function network (FBFN) rules. The device is capable of automatically pointing a main beam of a multi-beam planar array antenna on a base station to improve transiently a communication quality in the LMDS system on a bad weather condition. The correction device for the beam pointing error uses a multi-beam planar array antenna to obtain a direction-of-arrival (DOA) of a base station and uses a FBFN algorithm to estimate a beam pointing error so that a main beam of the planar array antenna can point at a main beam of the multi-beam planar array antenna on the base station so as to improve the quality of the communication. The FBFN algorithm includes thirteen normalized Gaussian membership functions and thirteen rules, which are generated based on the beam pointing error distribution caused by wind force.

2. Description of the Prior Art

Generally, an antenna of existing LMDS system can not automatically correct a beam pointing error, and usually causes the deterioration of the communication quality or the interruption of the communication, due to the beam pointing error caused by a strong wind force.

Conventionally, a mechanical type of a beam pointing adjustment usually employs an optimum filter to estimate a beam pointing error correction such that the beam can point at a signal source by means of a rotational antenna. However, except that the accuracy of the mechanical beam pointing adjustment can not be sufficiently high, the adjustment time thereof will be delayed due to the low response of the mechanical motor. With an array antenna using an electronically scanning manner, the main beam of the array antenna can be accurately, transiently pointing at a signal source by correcting a phase of each of the array elements, in order to increase an efficacy of the LMDS system.

However, the pointing error of the array antenna may be caused by using multi-beam signal comparison method, which irradiates a target by overlapping the irradiations of two adjacent beams of the multi-beam array antenna and compares the received signal amplitudes of these two different beam to obtain the direction-of-arrival (DOA). Provided that the estimated DOA value is employed directly to perform the correction for the beam pointing error, however, the beam pointing error will be too large; or the measured DOA value is employed to estimate the correction angle for the beam pointing error by means of RLS (recursive least square) optimum filter, however, the transient response error will be also too large, such that the quality of communication is affected. Both of the convergence speed and the beam pointing error convergence value thereof are hard to meet the requirement for accurately correcting the beam pointing error of LMDS system instantaneously.

### SUMMARY OF THE INVENTION

Therefore, in order to solve the above problems, an object of the invention is to provide a method for automatically correcting an array antenna beam pointing error of a local multipoint distributed system (LMDS) and a device thereof, such that a random beam pointing error of an antenna, which is caused by a strong wind force, can be automatically corrected in an instant to satisfy the requirements for a small transient response, a fast convergence speed as well as a low error of the beam pointing error correction. The invention utilizes normalized Gaussian membership functions, which are specified based on such as Racon model parameters of wind force distribution in Taiwan area, by means of a fuzzy basis function network (FBFN) processing device for the beam pointing error correction, in order to satisfy the requirements for a small transient response, a fast convergence speed as well as a low error of the beam pointing error correction.

For achieving the above object, in accordance with the invention, there is provided a FBFN (fuzzy basis function network) correction method for an array antenna beam pointing error of a local multipoint distribution system (LMDS), comprising the steps of:

a) using a multi-beam planar array antenna to receive a signal from a base station at a customer premise equipment (CPE) of a LMDS system;

b) generating a plurality of beam signals having different intensities in a fixed point on a horizontal direction from the received base station signal through a beam shaping circuit;

c) selecting two adjacent beam signals having the most strong intensities from the plurality of beam signals having different intensities and being subtracted with each other, so as to obtain an estimated direction-of-arrival (DOA) angular signal;

d) transferring the estimated DOA angular signal to a FBFN processing means for beam pointing error correction and performing a calculation of a correction angular signal in a FBFN algorithm; and

e) transferring the calculated correction angular signal to the beam shaping circuit to generate another beam and thereby pointing a main beam of the other beam to the base station for communication.

Further, in accordance with the invention, there is provided a FBFN (fuzzy basis function network) correction device for an array antenna beam pointing error of a local multipoint distribution system (LMDS), comprising:

a multi-beam array antenna, installed at a customer premise equipment (CPE) of a LMDS, for receiving a signal from a base station;

a beam shaping circuit, including a power divider and a phase shifter, for generating a plurality of beam signals having different intensities in a fixed pointing on a horizontal direction from the received base station signal;

a direction-of-arrival (DOA) estimation means, for selecting two adjacent beam signals having the most strong intensities from the plurality of beam signals having different intensities and being subtracted with each other to obtain an estimated direction-of-arrival (DOA) angular signal; and

a FBFN processing means, for beam pointing error correction, by receiving the estimated DOA angular signal and performing a calculation of a correction angular signal in a FBFN algorithm, and transferring the calculated correction angular signal to the beam shaping circuit to generated another beam and thereby pointing a main beam of the other beam to the base station for communication.

Further, the multi-beam array antenna is a two dimensional planar array antenna.

These and other objects, features and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures, wherein:

FIG. 1 is a block diagram, showing a function of a beam pointing error correction device of an array antenna of a LMDS system, in accordance with one embodiment of the invention;

FIG. 2 is a diagram, showing a signal flow of a beam pointing error correction device of an array antenna of the LMDS system, in accordance with the embodiment of the invention;

FIG. 3 is a diagram, explaining a two dimensimal planar array antenna formed of 12 pieces of antenna elements, in accordance with the embodiment of the invention;

FIG. 4(a) is graph, showing a 4-beams (beam 1 to beam 4) signal pattern on an xz plane of FIG. 3, in accordance with the invention, and FIG. 4(b) is a graph, showing a signal pattern of two adjacent corresponding beam difference on the xz plane of FIG. 3, in accordance with the invention;

FIG. 5(a) is a graph, showing a 2-beams (beam 1 to beam 2) signal pattern on a yz plane of FIG. 3, in accordance with the invention, and FIG. 5(b) is a graph, showing a signal pattern of adjacent corresponding beam difference on the yz plane of FIG. 3, in accordance with the invention;

FIG. 6 is a diagram, showing a FBFN beam pointing error correction device in accordance with the embodiment of the invention, which is obtained by a 4-layers construction;

FIG. 7 is a graph, explaining an average value and a variable (1.8, 0.86) of a Gaussian distribution of the beam pointing error, which is caused by a first pattern of wind force, in accordance with the embodiment of the invention;

FIG. 8 is a graph, explaining an average value and a variable (2.5, 1.7) of a Gaussian distribution of the beam pointing error, which is caused by a second pattern of wind force, in accordance with the embodiment of the invention;

FIG. 9 is a graph, explaining an average value and a variable (3.5, 3.4) of a Gaussian distribution of the beam pointing error, which is caused by a third pattern of wind force, in accordance with the embodiment of the invention;

FIG. 10 is a graph, explaining an average value and a variable (4.3, 6.9) of a Gaussian distribution of the beam pointing error, which is caused by a fourth pattern of wind force, in accordance with the embodiment of the invention; and

FIG. 11 is a graph, explaining an average value and a variable (6.1, 10.3) of a Gaussian distribution of the beam pointing error, which is caused by a fifth pattern of wind force, in accordance with the embodiment of the invention.

### BRIEF DESCRIPTION OF THE TABLE

Table 1 explains an example for a beam pointing error distribution simulating the wind force model in such as Taiwan area, in accordance with the embodiment of the present invention.

### DETAILED DESCRIPTION OF THE PREFERRED EMBODIMENTS

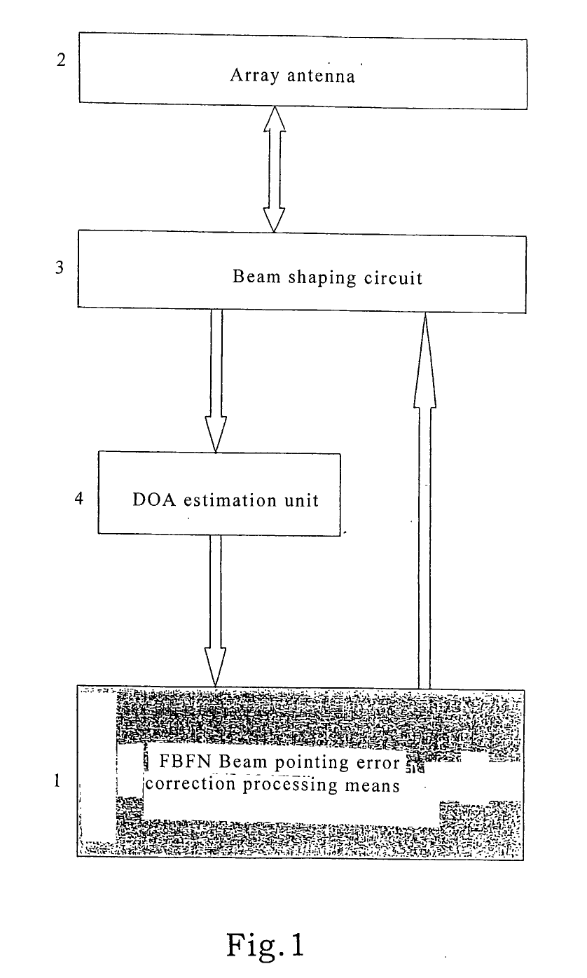

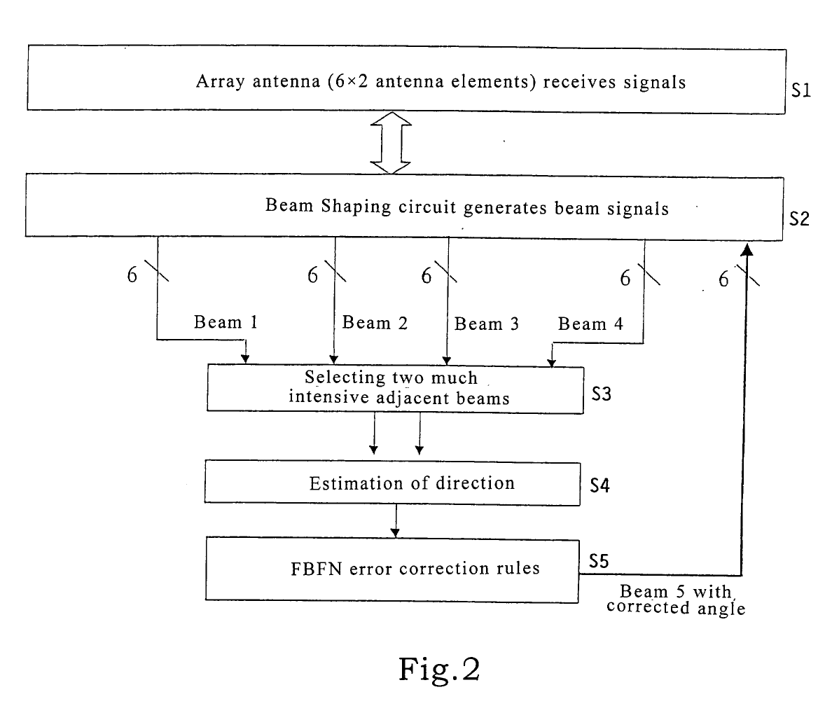

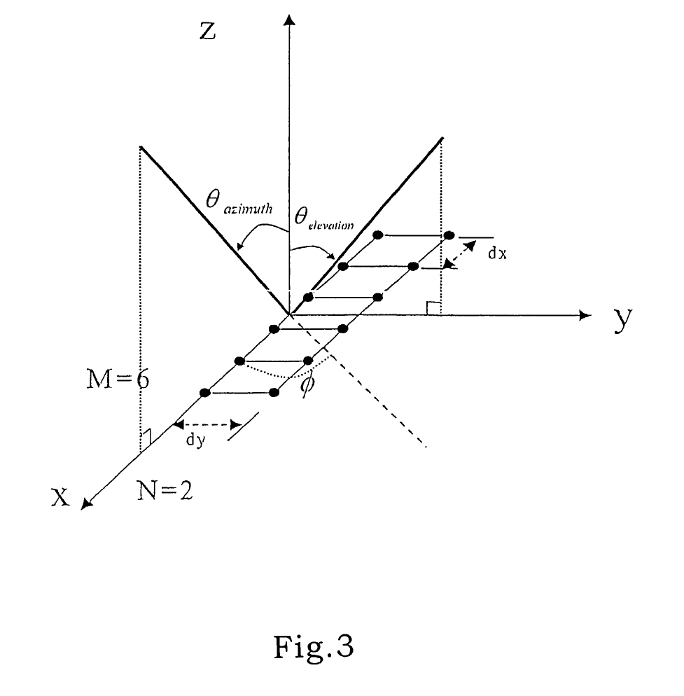

As shown in FIG. 1, FIG. 1 shows a functional block diagram of a beam pointing error correction device of an array antenna of a LMDS system in accordance with one embodiment of the invention, in that the left-hand side shadow block is a FBFN beam pointing error correction processing means 1, which is disclosed by the invention and is one of the main features of the invention; reference number 2 represents an array antenna; reference number 3 represents a beam shaping circuit; and reference number 4 represents a DOA estimation means. The signal flow of the device shown in FIG. 1 is illustrated in FIG. 2. FIG. 2 is a diagram showing a signal flow of a beam pointing error correction device of an array antenna of the LMDS system in accordance with the invention. As shown in FIG. 2 by using a multi-beam planar array antenna 2, a signal transmitted from a base station (not shown) is received at a customer premise equipment (CPE) of a LMDS system (not shown)(step S1); then, 4-beams signals having different intensities are generated by a beam shaping circuit in a horizontal fixed pointing direction (step S2); subsequently, two adjacent beam signals having the most strong intensities are selected from the 4-beam signals having different intensities (step S3) and subtracted to each other to generate an estimated direction-of arrival (DOA) angular signal (step S4); then, the estimated DOA angular signal is transferred to a FBFN processing means for beam pointing error correction and calculated to obtain a correction angle, and finally, the correction angle is transferred to the beam shaping circuit to generate a fifth beam, and a main beam of the fifth beam is pointed at the base station for communication, where the array antenna of the LMDS system is a two dimensional planar array antenna (2×6 antenna elements), which may perform an angular correction for both of the horizontal and vertical beam pointing error. The planar array antenna is arranged as shown in FIG. 3, the full pointing signal pattern of the antenna are:

$$AF = {\sum }_{n = 1}^{N} [ {\sum }_{m = 1}^{M} {I}_{m} {ⅇ}^{j ( m - 1 ) ( {kd}_{x} sin θcosφ + {β}_{x} )} ] {ⅇ}^{j ( n - 1 ) ( {kd}_{y} sin θcosφ + {β}_{y} )} \qquad ( 1 )$$

βₓ=−kdₓ sin θ₀ cos φ₀ (2)

β_{y}=−kd_{y} sin θ₀ cos φ₀ (3)

in that the weight of chebysher (lm) is [0.54 0.78 1 1 0.78 0.54], the element number of horizontal antenna (M) is 6, the element number of vertical antenna (N) is 2, the spacing between the elements of the horizontal antenna (dₓ) is λ/2, and the spacing between the elements of the vertical antenna (d_{y}) is λ/2, wherein λ is wavelength. By adjusting

(θ₀, φ₀) in equations (2) and (3), the main beam 0 will point at (θ₀, φ₀) to achieve a beam steering function in three dimensions.

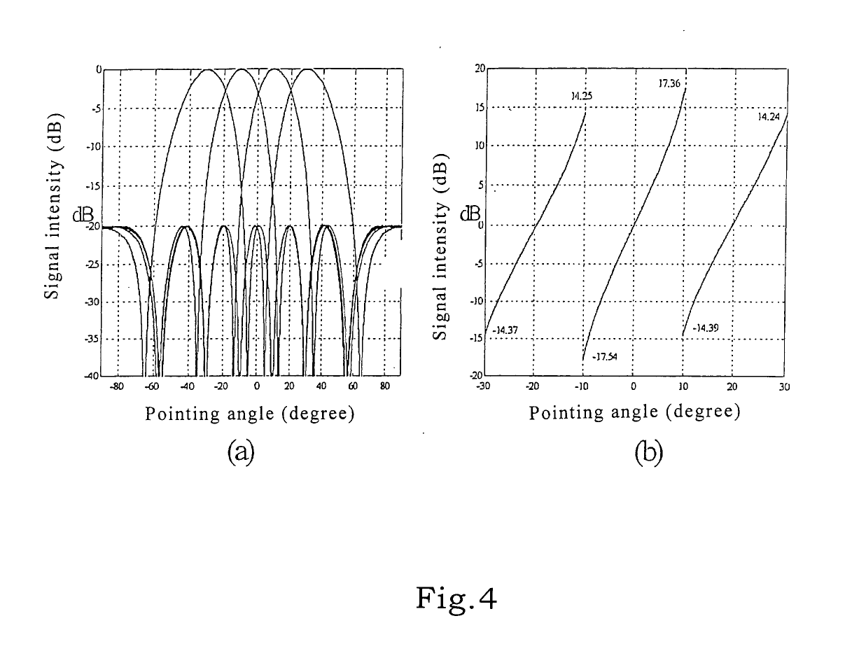

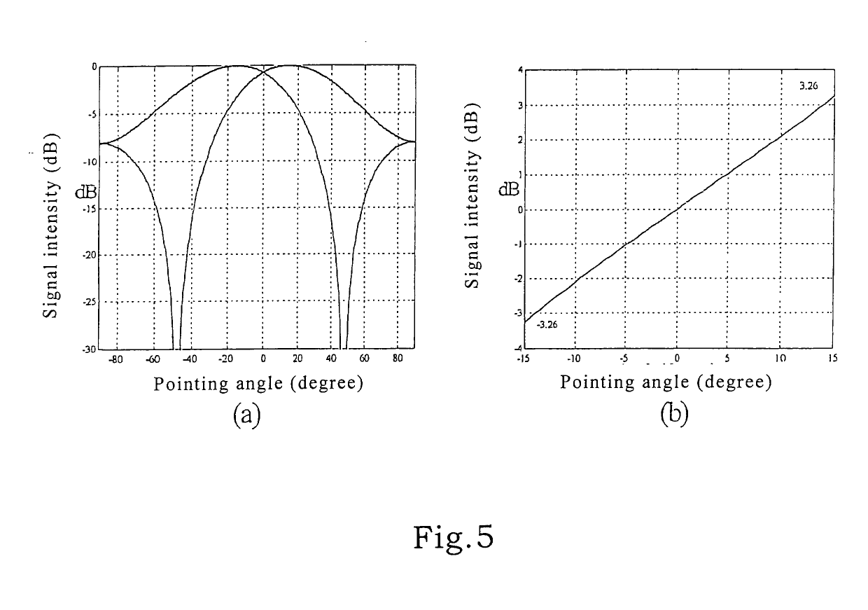

For achieving a three dimensional beam steering function, five multi-beam are formed on xz plane (θ_{azimuth}) by using a multi-beam shaping circuit 3, wherein beams 1 to 4 are used for the direction-of-arrival, beam 5 is used for pointing accurately. Three multi-beam are formed on yz plane (θₑₗₑᵥₐₜᵢₒₙ) by using a multi-beam shaping circuit 3, wherein beams 1 and 2 are used for the direction-of-arrival, beam 3 is used for pointing accurately. The multi-beam (beam 1 to beam 4) signal pattern generated on xz plane is shown on FIG. 4(a), its corresponding adjacent difference signal pattern is shown on FIG. 4(b). Angular slopes are 1.43, 1.75, 1.43 dB/degree, respectively. The multi-beam (beams 1 and 2) signal pattern generated on yz plane is shown on FIG. 5(a), its corresponding adjacent difference signal pattern is shown on FIG. 5(b). Angular slope is 0.217 dB/degree. The estimated DOA can be obtained by using the angular slope to divide a power difference between two adjacent beam receiving signal.

The multi-beam shaping circuit 3 consists of a power divider 31 (not shown) and a phase shifter 32(not shown), for generating a fixed pointing multi-beam signal for estimation of DOA in post stages. The adjacent two beams of the multi-beam planar array antenna generate a difference signal pattern to perform an estimation of the DOA by using an amplitude comparison method. The direction of the signal source can be resolved by a power difference value of signal of each received beam, the value of which corresponds to the value of the difference signal pattern.

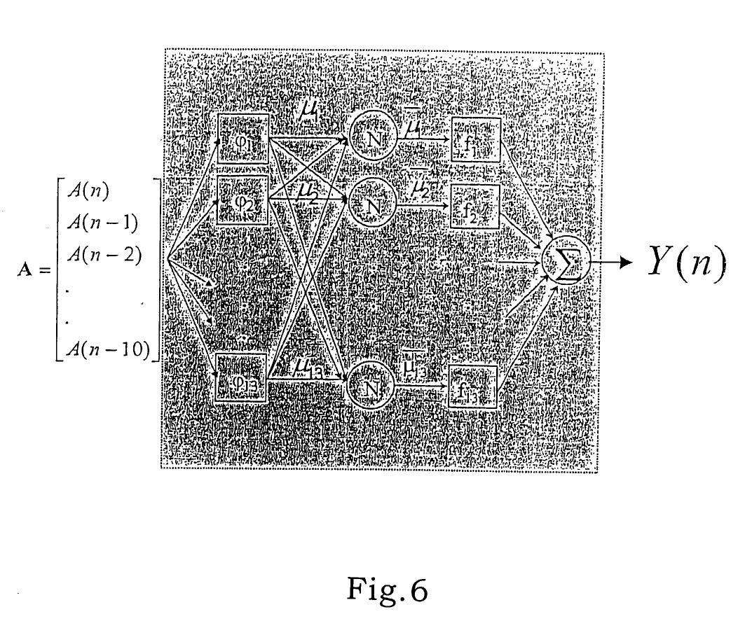

The beam pointing error correction processing means 1 can be designed having a one step forward prediction filter 11 (not shown) by a FBFN fuzzy value for the compensation of the beam pointing error angel which is caused by a random disturbance of a strong wind. To improve the random beam pointing error of the LMDS array antenna system caused by the strong wind. The present invention employs the FBFN beam pointing error correction processing means to make a better correction for the beam pointing error on the distribution of the beam pointing error with respect to each of the time. The FBFN beam pointing error correction processing means 1 is shown as FIG. 6. The first layer of thirteen attribution functions are normalized Gaussian functions which are set in accordance with, for example, the racon mode parameters σ² of the Taiwan area wind force distribution, presented by Dr. Wang of National Central University in Taiwan, as shown in Table 1.

TABLE 1

| | Average value of | Variables of | |
|---|---|---|---|
| | Gaussian | Gaussian | |
| Beaufort | distribution | distribution | Racon distribution |
| scale | E{r}degree | Var{r²}(degree) | Parameters σ² |
| 4 | 1.8 | 0.86 | 2 |
| 5 | 2.5 | 1.7 | 4 |
| 6 | 3.5 | 3.4 | 8 |
| 7 | 4.3 | 6.9 | 16 |
| 8 | 6.1 | 10.3 | 24 |

Because the cause of the beam pointing error is mainly due to a shift of the structure of the antenna main body, thus a simulation experiment for the presentation is under the assumption of wind force below four degrees of wind forces, which is sufficient to allow the structural rigid feature of the antenna to keep an accurate pointing for the beam. Assuming that the average of the pointing error distribution under four degrees of wind force is 1.8 and the variable of Gaussian distribution is 0.86, the variables and averages of other wind forces are linearly increased with the enhancements of the wind forces. Then, the FBFN attribution function and weights of each rules are determined according to these data. If the beam pointing error mode caused by the strong wind is Gaussion distribution, the average thereof can be obtained by:

$$E [ r ] = σ \cdot \sqrt{\frac{π}{2}} ; \qquad ( 4 )$$

the variable can be obtained by:

Var[r]=(2−π/2)σ² (5);

the normalized Gaussian attribution function can be obtained by

$${ϕ}_{i} ( \vec{x} ) = exp \{ - \frac{{‖ \vec{x} - {\vec{C}}_{i} ‖}^{2}}{{δ}_{i}^{2}} \} , i = 1 , 2 , … 13 \qquad ( 6 )$$

input vector \vec{X}=\vec{A}=[A[n]A[n−1] . . . A[n−10]]

in which \vec{C}ᵢ is a central vector of Gaussian function, in that \vec{C}ᵢ includes eleven sampling vectors, each of the parameters represents:

A(n)˜A(n−10): values of beam pointing error angles at the nth to (n−10)th times;

φ₁˜φ₁₃: input attribution function set by the deviation distribution of the antenna;

μ₁˜μ₁₃: triggering strength of each rule

μᵢ=φᵢ(\vec{A}) (7)

μ₁˜μ₁₃: normalized triggering strength

$${\overline{μ}}_{i} = \frac{{μ}_{i}}{{\sum }_{ i}^{} {μ}_{i}} i = 1 , … , 13 \qquad ( 8 )$$

f₁˜f₁₃: output weight of rear item associated with each rule.

Output compensation Y(n)=\overline{μ}ᵢ,fᵢ (9)

In the present invention, it is deemed that the beam pointing errors caused by the wind forces may have distribution of negative averages and may generate a smaller disturbance of wind force in actual situation. The present invention refers to the inclination of five kinds of wind force distributions, and designs thirteen normalized Gaussian attribution functions and output weights of rear items. The parameters are set as following:

| | |
|---|---|
| \overline{C}₁ = [−6.14]₁ₓ₁₁^{T} | f₁ = −6.14 |
| \overline{C}₂ = [−5]₁ₓ₁₁^{T} | f₂ = −5 |
| \overline{C}₃ = [−3.5]₁ₓ₁₁^{T} | f₃ = −3.5 |
| \overline{C}₄ = [−2.5]₁ₓ₁₁^{T} | f₄ = −2.5 |
| \overline{C}₅ = [−1.7]₁ₓ₁₁^{T} | f₅ = −1.7 |
| \overline{C}₆ = [−0.5]₁ₓ₁₁^{T} | f₆ = −0.5 |
| \overline{C}₇ = [0]₁ₓ₁₁^{T} | f₇ = 0 |
| \overline{C}₈ = [0.5]₁ₓ₁₁^{T} | f₈ = 0.5 |
| \overline{C}₉ = [1.7]₁ₓ₁₁^{T} | f₉ = 1.7 |
| \overline{C}₁₀ = [2.5]₁ₓ₁₁^{T} | f₁₀ = 2.5 |
| \overline{C}₁₁ = [3.5]₁ₓ₁₁^{T} | f₁₁ = 3.5 |
| \overline{C}₁₂ = [5]₁ₓ₁₁^{T} | f₁₂ = 5 |
| \overline{C}₁₃ = [6.14]₁ₓ₁₁^{T} | f₁₃ = 6.14 |
| σᵢ = 2, i = 1˜13 | |

[Preferred Embodiment]

Five kinds of Gaussian angular distributions of beam pointing errors generated in simulation experiment are transferred to the beam pointing error correction processing device for performing the correction for the beam pointing angle. Through the five kinds of Gaussian angular distributions of beam pointing errors associated with the five kinds of wind force distributions, the average (m) and variable (σ²) thereof are obtained as (m, σ²)=(1.8, 0.86), (2.5, 1.7), (3.5, 3.4), (4.3, 6.9), (6.1, 10.3), which are called as the first type to the fifth type of the Gaussian distributions, respectively.

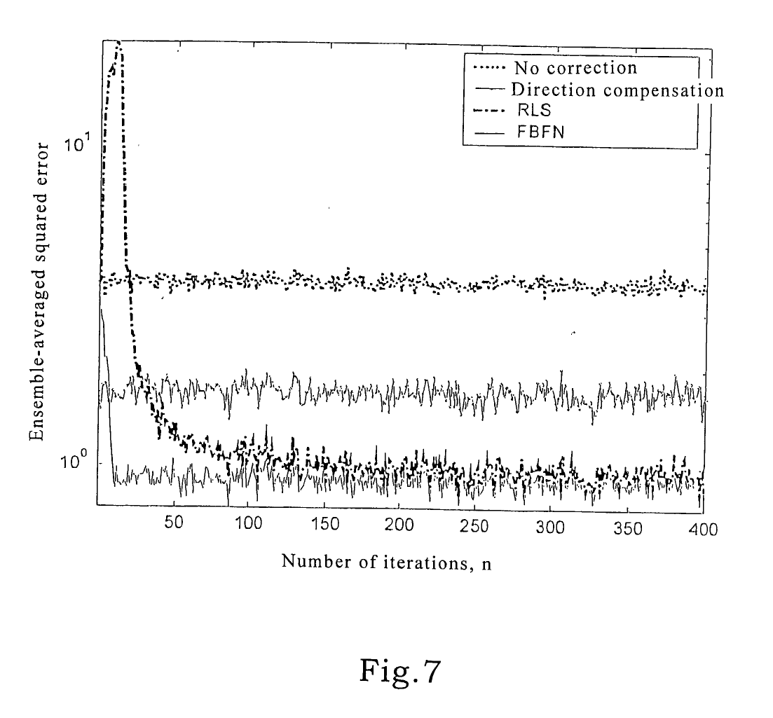

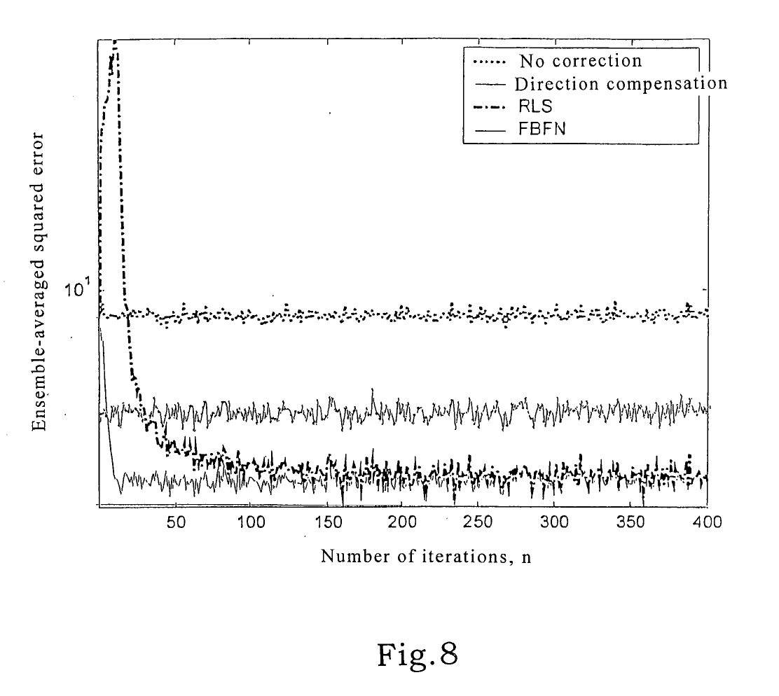

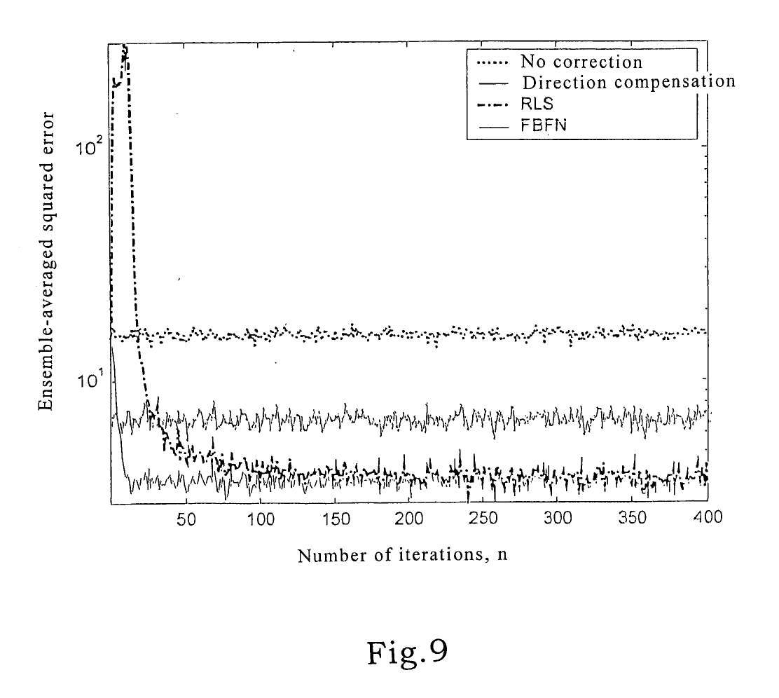

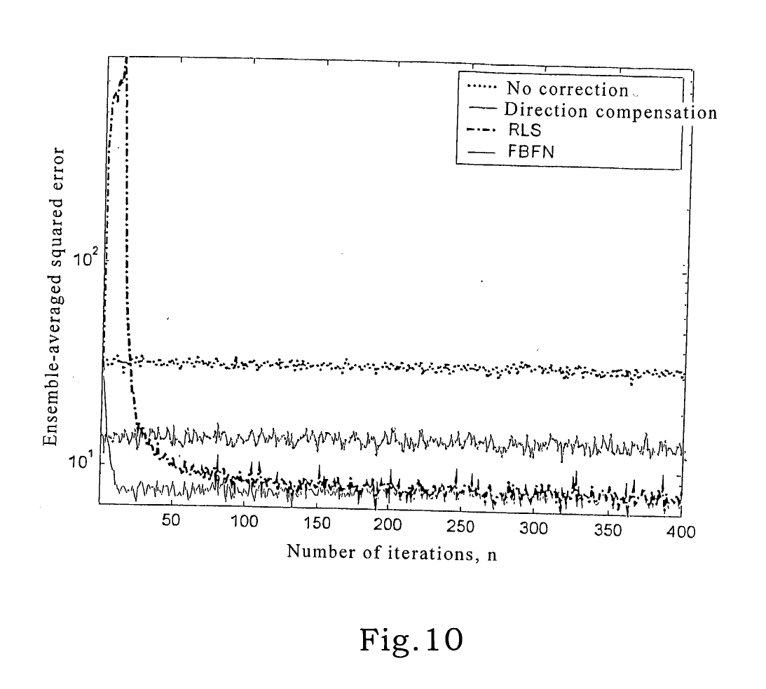

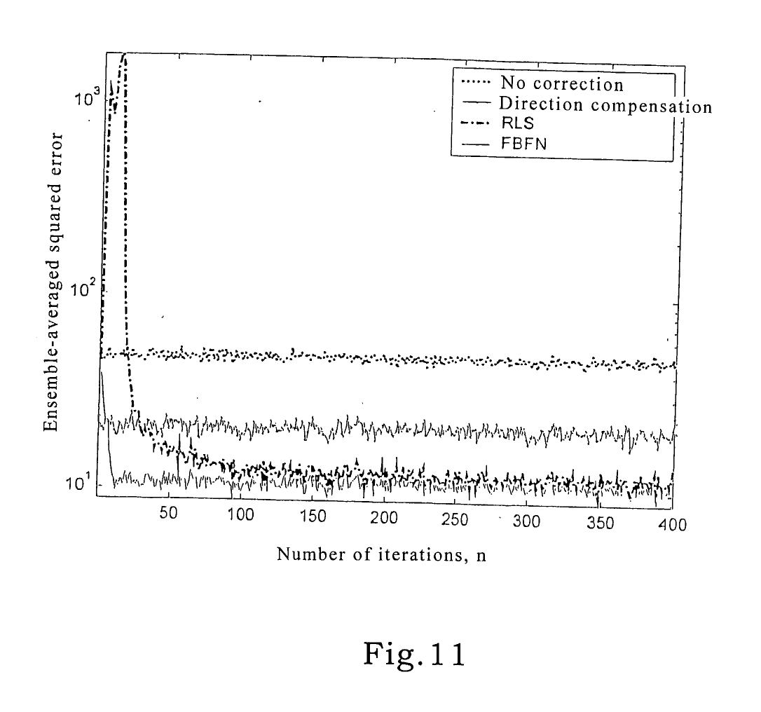

400 points of data are input to FBFN circuit and eleven steps filter of the recursive least square (RLS) are performed for the Monte-Carlo experiment 500 times. The results of the simulation experiment are shown in FIG. 7 to FIG. 11.

In the drawings, four learning curves represent the meanings as following:

no correction curve: representing the ensemble-averaged square error caused by the wind force, ensemble-averaged square error=

$$\frac{1}{500} {\sum }_{i = 1}^{500} \{ {[ {A}_{i} ( n + 1 ) ]}^{2} \} ; \qquad ( 10 )$$

direct compensation curve: representing that using directly DOA estimated values to compensate the generated ensemble-average square error,

direct compensated ensemble-averaged square error=

$$\frac{1}{500} {\sum }_{i = 1}^{500} \{ {[ {A}_{i} ( n + 1 ) - {A}_{i} ( n ) ]}^{2} \} ; \qquad ( 11 )$$

RLS curve: representing that using the recursive least square (RLS) to predict the ensemble-averaged square error after compensated by the filter,

RLS ensemble-averaged square error=

$$\frac{1}{500} {\sum }_{i = 1}^{500} \{ {[ {A}_{i} ( n + 1 ) - {Y}_{i} ( n ) ]}^{2} \} ; \qquad ( 12 )$$

FBFN curve: representing the ensemble-averaged square error after correction processing by using FBFN fuzzy rules,

FBFN ensemble-averaged square error=

$$\frac{1}{500} {\sum }_{i = 1}^{500} \{ {[ {A}_{i} ( n + 1 ) - {Y}_{i} ( n ) ]}^{2} \} . \qquad ( 13 )$$

Comparing the FBFN beam pointing error correction processing device with the RLS optimum filter, the results of the experiments show the ensemble-averaged square error of the RLS optimum filter, the results of the experiments show the ensemble-averaged square error of the RLS optimum filter may close to a stable value at the number of iterations) n=60˜80. However, the transient response of the RLS becomes large (the ensemble-averaged square error may be up to 10¹˜10³) which is apt to cause the deterioration of the communication quality in LMDS system. It is found that there is a satisfactory transient response value in FBFN beam pointing error correction processing device (The ensemble-averaged square error is 1˜10² approximately.), preferably, the convergence speed is n=10˜20 and there exists a lower convergence value of the beam pointing error correction. The results of the simulation show that the FBFN beam pointing error correction processing device can satisfy the application requirements of small transient response, fast convergence speed and lower beam pointing convergence error. Indeed, the present invention is capable of improving the communication quality of the LMDS system.

Having described the preferred embodiments of the invention, however, which are not intended to be the limit of the invention. It is noted that modifications and variations can be made by persons skilled in the art in light of the above teachings. It is therefore to be understood that various changes, equivalences and modifications may be made in the particular embodiments of the invention disclosed without departing from the scope and spirit of the invention as outlined by the appended claims.

LIST OF REFERENCE NUMERALS

| | |
|---|---|
| 1 | FBFN beam pointing error correction processing means |
| 2 | array antenna |
| 3 | beam shaping circuit |
| 4 | DOA estimation means |
| 11 | power divider |
| 31 | phase shifter |
| 32 | filter |

What is claimed is:

1. A FBFN (fuzzy basis function network) correction method for an array antenna beam pointing error of a local multipoint distribution system (LMDS), comprising the steps of:
a) using a multi-beam array antenna to receive a base station at a customer premise equipment (CPE) of a LMDS;
b) generating a plurality of beam signals having different intensities in a fixed pointing on a horizontal direction from the received base station signal through a beam shaping circuit;
c) selecting two adjacent beam signals having the most strong intensities from the plurality of beam signals having different intensities and being subtracted with each other, so as to obtain an estimated direction-of-arrival (DOA) angular signal;
d) transferring the estimated DOA angular signal to a FBFN processing means for beam pointing error correction and performing a calculation of a correction angular signal in a FBFN algorithm; and
e) transferring the calculated correction angular signal to the beam shaping circuit to generated another beam and thereby pointing a main beam of the another beam to the base station for communication.

2. The method as claimed in claim 1, wherein the multi-beam array antenna is a two dimensional planar array antenna.

3. A FBFN (fuzzy basis function network) correction device for an array antenna beam pointing error of a local multipoint distribution system (LMDS), comprising:
a multi-beam array antenna, installed at a customer premise equipment (CPE) of a LMDS, for receiving a signal from a base station;
a beam shaping circuit, including a power divider and a phase shifter, for generating a plurality of beam signals having different intensities in a fixed pointing on a horizontal direction from the received base station signal;
a direction-of-arrival(DOA) estimation means, for selecting two adjacent beam signal having the most strong intensities from the plurality of beam signals having different intensities and being subtracted with each other to obtain an estimated direction-of-arrival (DOA) angular signal; and
a FBFN processing means, for beam pointing error correction, by receiving the estimated DOA angular signal and performing a calculation of a correction angular signal in a FBFN algorithm, and transferring the calculated correction angular signal to the beam shaping circuit to generate another beam and thereby pointing a main beam of the other beam to the base station for communication.

4. The device as claimed in claim 3, wherein the multi-beam array antenna is a two dimensional planar array antenna.
